(19) United States
(12) Patent Application Publication
(10) Pub. No.: US 2013/0098713 A1
(43) Pub. Date: Apr. 25, 2013

(54) ELEVATOR CAR AND METHOD FOR OPERATING AN ELEVATOR SYSTEM WITH AN ELEVATOR CAR

(71) Applicants: Andreas Urben, Luzern (CH); Marcel Nicole, Stansstad (CH); Matthias Sager, Kussnacht a/Rigi (CH); Stefan Buntschu, Port Macquarie (AU); Daniel Risi, Aristau AG (CH); Marco Schupfer, Knonau (CH); Tobias Hanni, Luzern (CH); Muhamed Sabanovic, Lucerne (CH)

(72) Inventors: Andreas Urben, Luzern (CH); Marcel Nicole, Stansstad (CH); Matthias Sager, Kussnacht a/Rigi (CH); Stefan Buntschu, Port Macquarie (AU); Daniel Risi, Aristau AG (CH); Marco Schupfer, Knonau (CH); Tobias Hanni, Luzern (CH); Muhamed Sabanovic, Lucerne (CH)

(73) Assignee: INVENTIO AG, Hergiswil NW (CH)

(21) Appl. No.: 13/695,947

(22) PCT Filed: Apr. 21, 2011
(86) PCT No.: PCT/EP2011/056407

§ 371 Date: Jan. 9, 2013

(30) Foreign Application Priority Data
May 3, 2010 (EP) 10161780.1

(51) Int. Cl. B66B 11/02

(52) U.S. Cl. CPC B66B 11/0226
USPC 187/401

(57) ABSTRACT

An elevator car has an aerodynamic cladding which in an upward travel direction of the elevator car is disposed above an upper side of the elevator car and which is connected with the elevator car. An attachment structure serves as a cladding, which is of self-supporting construction. The elevator car has an opening mechanism which is designed for transferring a movable superstructure of the attachment structure from a closed state to an open state.

### FIELD

The invention relates to an elevator car with an aerodynamic cladding and to a method of operating an elevator installation with such an elevator car.

### BACKGROUND

Wind noise and vibrations arise due to air turbulence at and around the external contours of an elevator car during travel at high speeds from approximately 4 m/sec. The technically and functionally imposed form of an elevator car with the various edges, projections and flat end faces at the bottom and top does not represent an ideally shaped vehicle from the aerodynamic aspect.

For reduction in the air turbulence generating noise and vibration the elevator car should have a body shape along which the air displaced during travel should be able to flow as free of turbulence as possible. Such a shape can in principle be achieved by means of vertically protruding body-attached structures which are arranged at the top and bottom faces of an elevator car.

Numerous elevator cars with streamlined hoods at the upper and lower sides of the elevator car are known from the prior art. Unfortunately, in the case of these solutions, which are primarily based on aerodynamic optimization, access to elements and components of the elevator car at the roof is difficult. In addition, evacuation of the elevator car in upward direction can be obstructed by an aerodynamic cladding.

Various aerodynamic cladding elements, which are arranged at a support structure or frame structure at a specific spacing above and below the actual elevator car, are known from U.S. Pat. No. 6,047,792A. Due to the fact that these cladding elements have a spacing from the elevator car, elements directly above or below the elevator car can to some extent be easily reached. However, it is a disadvantage with this solution that it is not possible to work standing on the upper side of the elevator car. Moreover, the elevator car cannot be evacuated, or can be evacuated only with difficulties, from the upper side.

### SUMMARY

It is therefore an object of the present invention to avoid the disadvantages of the prior art and, in particular, to provide an elevator car of the kind stated in the introduction which has an aerodynamic cladding which during normal operation provides excellent aerodynamic values, but which in the maintenance mode or the in the case of evacuation nevertheless makes possible the required access or escape in simple mode and manner.

Due to the fact that the elevator car according to the invention comprises an opening mechanism, which, for example, is manually operable or activatable or is controllable by way of control means and which is designed for the purpose of transferring at least one movable part of the attachment structure from a closed state to an open state, it is possible to achieve various advantages. Complete demounting of the cladding for carrying out maintenance operations as in the case of conventional elevators with claddings is no longer required. The mentioned movable part is formed to be hood-shaped. If the cladding is flattened at the end facing in upward direction, wherein the flattening is formed by a plate-shaped element oriented vertically with respect to the travel direction, then it would, however, basically also be conceivable to design only the plate-shaped element to be movable by means of the opening mechanism for transfer to the open state. The hood can, for example, be made from a single sheet-metal blank or from a plurality of sheet-metal blanks connected together. Other materials such as, for example, plastics material or fiber-composite materials are obviously also conceivable, instead of metallic materials, for the cladding.

The movable part or hood-shaped cladding part can have a recess, for example in the form of a circular opening, through which the support means can pass or are passed.

It can be advantageous if at least the movable part of the attachment structure is transferable or raisable from the closed state to the open state by means of the opening mechanism in a vertical translational movement. The raising of the movable cladding can be managed with use of mechanical, hydraulic or pneumatic lifting means.

According to the invention the attachment structure comprises, as movable part, a superstructure. In addition, the attachment structure comprises a substructure fixedly connected with the elevator car. The substructure can in the open state serve as a balustrade or railing which surrounds a protected region above the elevator car. Additional safety means, for example handrails, are no longer required. For substantially block-shaped cars the substructure can consist of four wall sections connected with one another. It can be advantageous if, as considered in upward direction, the wall sections are at least slightly directed towards one another or if the cavity between the wall sections narrows in upward direction. Moreover, it can be advantageous if for good aerodynamics the wall sections have a curved profile in a cross-sectional view.

The elevator car can have at the door side a preferably substantially vertically extending wind deflector. The wind deflector can in that case form a side wall of the cladding or the hood. Such wind deflectors can be a component of the superstructure and/or of the substructure.

The superstructure can be mounted to be movable relative to the elevator car vertically translationally or in travel direction, preferably by means of the opening mechanism. This arrangement has, inter alia, the advantage that the roof upper side of the car is accessible in particularly simple manner after the opening process. The opening mechanism can be designed in such a manner that in the open state, for example, a clear spacing between the movable part and the car, which is stationary relative thereto, of at least 30 centimeters and preferably at least 50 centimeters can be achieved. An opening spacing of at least 50 centimeters also ensures comparatively easy evacuations. However, other constructional shapes are obviously also conceivable. Thus, for example, the hood or the superstructure could be pivotably mounted on the car or on the substructure.

The present invention relates particularly to a device for reducing wind noise and vibrations at high-speed elevator cars, comprising at least one aerodynamic element, which is attached to the elevator car, with a possibility of access to the car roof.

The invention is particularly distinguished by the fact that in a special situation (maintenance, assembly or, for example, in the case of evacuation) it creates a spacing between the upper side of the elevator car and a movable part of the cladding, whereby the car upper side is, for example, accessible to a service engineer or whereby in the case of evacuation an advantageous escape route is created.

The opening mechanism can comprise holding means which are temporarily fastenable to counter-holders, which in turn are associated with an elevator shaft. It is thereby possible in simple mode and manner for the superstructure to be brought into a parked position. An arrangement of that kind can also be advantageous for other elevator cars provided with claddings. Thus, for example, a two-part construction of the cladding with superstructure and substructure is not absolutely necessary. The sequence can, for example, be as follows: In a holding position the mentioned holding means are temporarily mounted on the counter-holders of the elevator installation in order to fix the movable part of the attachment structure or the hood to the counter-holders by way of the holding means. In a downstream step the elevator car executes a downward movement in order to thus create a spacing between an upper side of the elevator car and the movable part of the attachment structure or the hood.

It can be particularly advantageous if the opening mechanism comprises clamping bodies which are temporarily fastenable to stationary guide rails in order to thus bring the superstructure into a parked position.

### DESCRIPTION OF THE DRAWINGS

Further individual features and advantages of the invention are also evident from the following description of embodiments and from the drawings, in which:

FIG. 1A shows a simplified illustration of an elevator car with closed aerodynamic cladding;

FIG. 1B shows the elevator car according to FIG. 1A with opened aerodynamic cladding;

FIG. 2 shows a simplified illustration of a further elevator car with opened aerodynamic cladding;

FIG. 3 shows a simplified illustration of an elevator car according to the invention with a two-part aerodynamic cladding, wherein this cladding is indicated in a closed setting and an open setting;

FIG. 4A shows a perspective illustration of a further elevator car according to the invention with two-part aerodynamic cladding in a closed setting;

FIG. 4B shows a perspective illustration of the elevator car according to FIG. 4A in an open setting;

FIG. 5 shows a perspective illustration of a further aerodynamic cladding in an open setting, according to the invention;

FIG. 6 shows a simplified illustration of an upper region of an elevator car according to the invention with a first opening mechanism and an opened superstructure;

FIG. 7 shows a simplified illustration of an upper region of an elevator car according to the invention with a further opening mechanism and a opened superstructure;

FIG. 8 shows a simplified illustration of an upper region of an elevator car according to the invention with a further opening mechanism and an opened superstructure;

FIG. 9A shows a simplified illustration of an upper region of an elevator car according to the invention with a further opening mechanism with a closed aerodynamic cladding;

FIG. 9B shows a simplified illustration of the upper region of the elevator car according to FIG. 9A when the aerodynamic cladding is opened;

FIG. 9C shows a simplified illustration of the upper region of the elevator car according to FIG. 9A in the opened state of the aerodynamic cladding;

FIG. 10 shows a simplified illustration of an upper region of an elevator car according to the invention with a further opening mechanism and an opened superstructure;

FIG. 11 shows a simplified illustration of an upper region of an elevator car according to the invention with a further opening mechanism and an opened superstructure;

FIG. 12 shows a simplified illustration with an alternative elevator car shortly before coupling of the superstructure; and

FIG. 13 shows the elevator car according to FIG. 12 with the superstructure, which is coupled with a shaft ceiling, and a car after the coupling process and downwardly moved.

### DETAILED DESCRIPTION

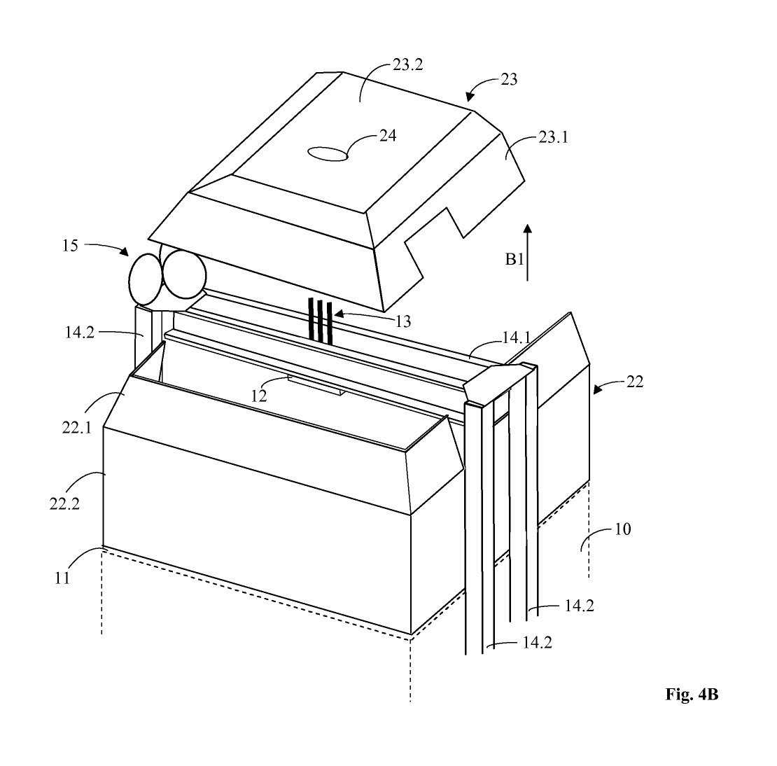

The term “fastening means 12” is used in connection with the present invention. These fastening means 12 comprise one or more mechanical components which make it possible to suspend the elevator car 10 at a support means 13. A rectangular plate 12, which is seated below a crossbeam 14.1 in order to thus connect the elevator car 10 with the three support means 13, can be seen in FIG. 4B by way of an example. Numerous other previously known components can also be used here. The fastening means 12 can, for example, also comprise deflecting rollers, for example in the case of an elevator car 10 with under-looping, or clamping/screw-fastenings.

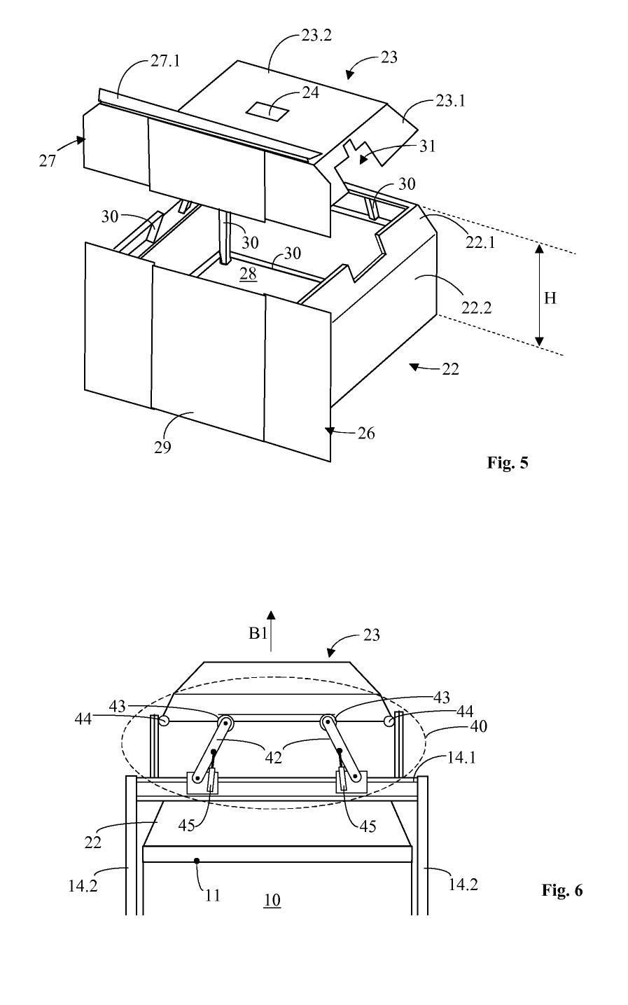

In connection with the present invention the term “self-supporting” is used in order to describe that the part concerned or the component concerned intrinsically has a high level of stiffness. This stiffness has to be selected so that the self-supporting part or the relevant self-supporting component can be completely displaced, shifted, pivoted or otherwise moved away. The self-supporting part or the relevant self-supporting component preferably comprises a support frame 30 (see FIG. 5) with cladding elements or the cladding structure is inherently self-supporting, as known from bodywork construction.

The term “attachment structure 21” denotes the self-supporting structure from which the aerodynamic cladding 20 is formed. The attachment structure 21 can be of unitary construction, i.e. the attachment structure 21 is designed as an entire self-supporting part. In a further form of embodiment the attachment structure 21 comprises a substructure 22 and a superstructure 23, thus is of two-part construction. In that case at least the superstructure 23 is designed as a self-supporting part. The substructure 22 can optionally also be constructed as a self-supporting part.

The term “opening mechanism 40” is used to describe mechanical, magnetic, electromechanical, electromagnetic, hydraulic or gas pressure means which are designed for the purpose of displacing, shifting, pivoting away or otherwise moving away the attachment structure as a whole or the superstructure 23 of the attachment structure 21.

By the term “closed state” there is to be understood a state in which the aerodynamic cladding 20 or parts thereof is or are disposed in an optimum position for upward or downward travel of the elevator car 10. This is thus the position which the aerodynamic cladding 20 adopts in normal operation.

By the term “open state” there is to be understood a state in which the aerodynamic cladding 20 or parts thereof was or were displaced, shifted, pivoted away or otherwise moved out of the closed state. Preferably, in the open state at least a part of the element or components, which is or are at the roof side, of the elevator car 10 are accessible to a service engineer. This is a position which the aerodynamic cladding 20 adopts in assembly or maintenance or, for example, also in the case of an evacuation.

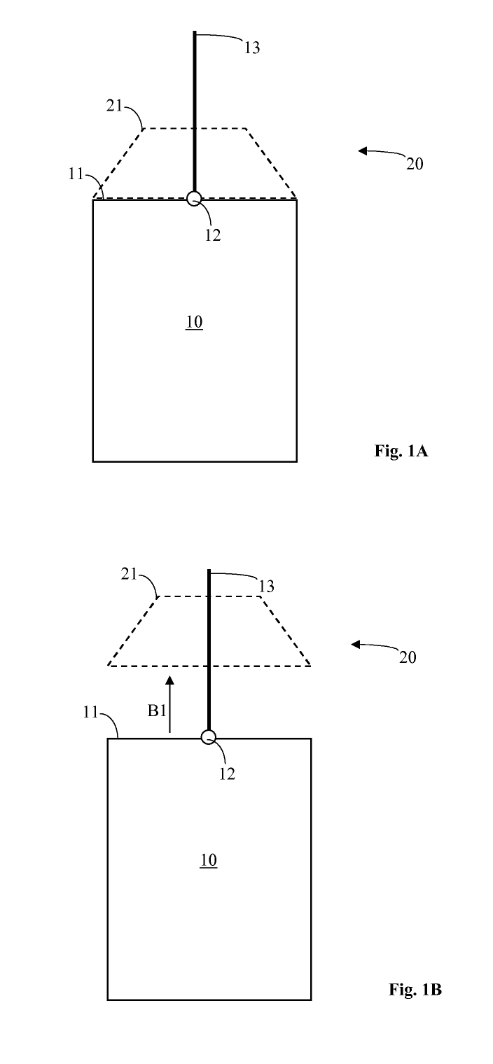

The basic construction of aerodynamic elevator cars is now explained with reference to FIGS. 1A and 1B. FIG. 1A shows an elevator car 10 with an aerodynamic cladding 20 in the closed state, whilst FIG. 1B shows the elevator car 10 with aerodynamic cladding in the open state.

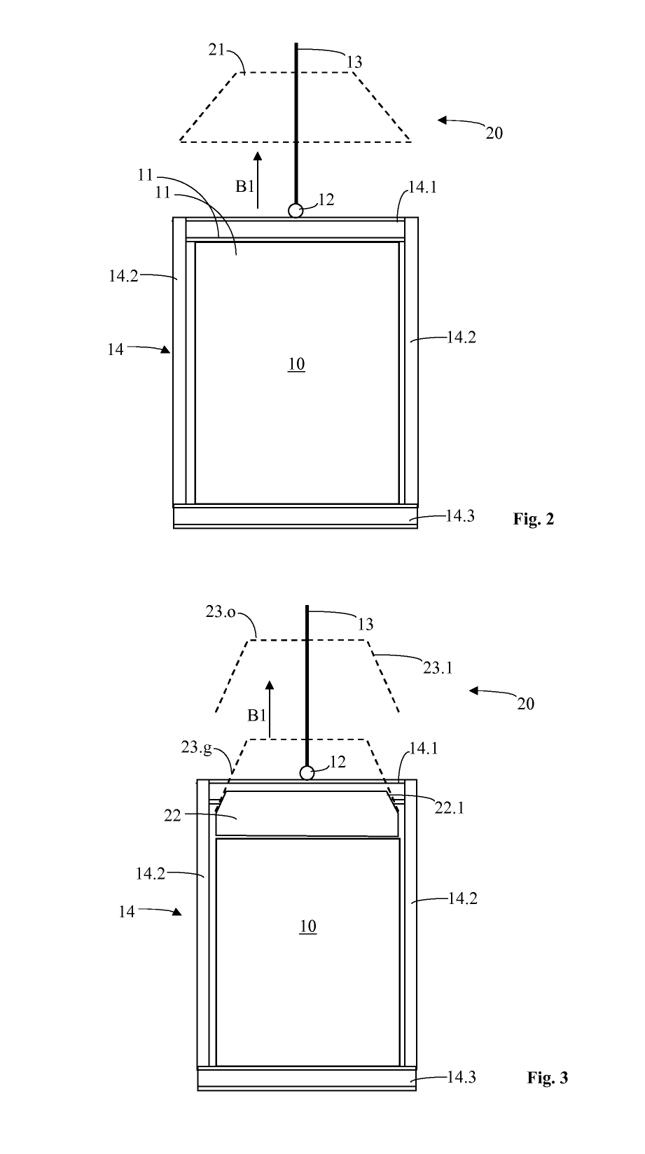

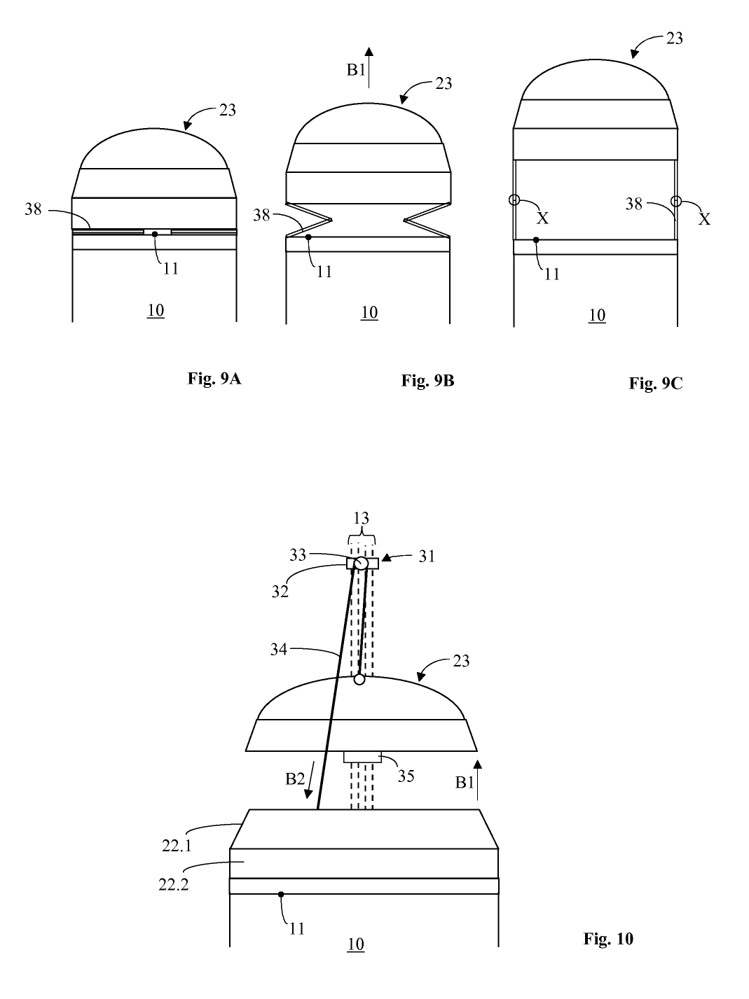

The elevator car 10 is provided with an aerodynamic cladding 20 which as considered in the upward travel direction of the elevator car 10 is disposed above an upper side 11 of the elevator car 10. Shown in FIGS. 1A, 1B, 2, 3, 4A, 4B, 5, 6, 7 and 8 are hood-shape claddings 20, the outlines of which in cross-section each form a trapezium (the trapezium-shaped claddings are respectively illustrated in FIGS. 1A, 1B and 2 by dashed lines). The claddings 20 can, however, also be dome-shaped (see, for example, FIGS. 9A-9C, FIG. 10 and FIG. 11), conical or frustoconical or have any other aerodynamically advantageous form.

The cladding 20 could additionally also have an ellipsoidal shape with curved outer surfaces and spherically shaped transitions.

The cladding 20 is mechanically connected with the elevator car 10 or with a car frame 14 (see FIGS. 2, 3, 4A, 4B, 6 and 11). Moreover, the elevator car 10 comprises fastening means 12 for fastening the elevator car 10 to a support means 13. In each instance 1:1 suspensions are shown in the Figures. The invention can also be used for other suspension shapes (for example, systems with under-looping).

An attachment structure 21 serves as cladding 20. The attachment structure 21 is self-supporting and constructed so as to be at least partly movable. In addition, the elevator car 10 comprises an opening mechanism 40 (FIG. 6) which is suitable for the purpose of transferring the attachment structure 21 from a closed state to an open state, wherein the attachment structure 21 in the closed state is disposed closer to the upper side 11 of the elevator car 10 than in the open state. In FIG. 1B a corresponding linear opening movement is indicated by an arrow B1. However, folding, rotational and pivot movements are also possible as opening movement. The opening mechanism 40 can be appropriately differently designed and arranged.

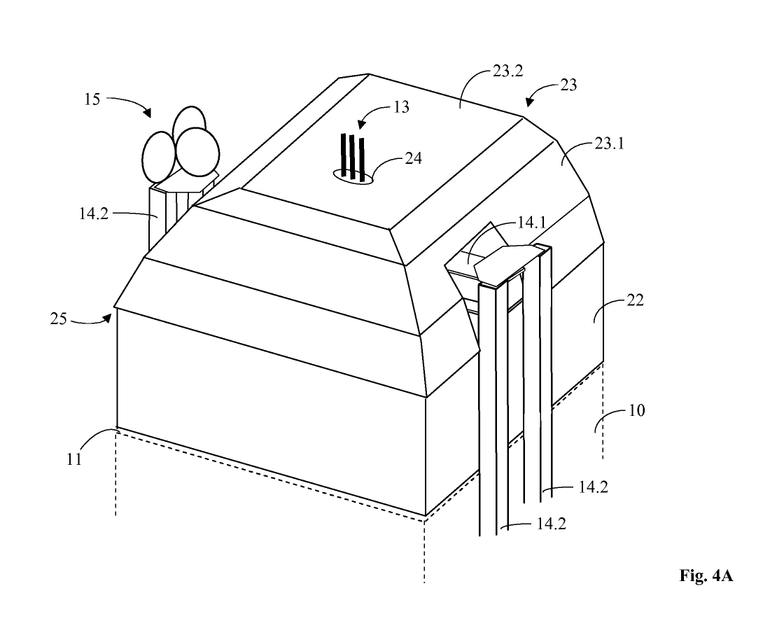

The aerodynamic cladding 20 is preferably used in elevator cars 10 of high-speed elevator installations. In this case the elevator car 10 typically comprises a load-bearing car frame 14 (rectangular frame) which—as shown in, for example, FIGS. 2 and 3 by way of two forms of embodiment—at least partly surrounds or encloses the elevator car 10.

An elevator car is shown in FIG. 2 in which a rectangular car frame 14 completely surrounds the elevator car 10. The car frame 14 here comprises an upper crossbeam 14.1 at which at the same time the or each support means 13 is fastened with use of suitable fastening means 12. In addition, the car frame 14 comprises two lateral beams 14.2 and a lower crossbeam 14.3. These beams 14.1, 14.2, 14.3 can be welded, screw-connected, riveted or glued together.

The open position of the attachment structure 21, which serves as cladding 20, is indicated in FIG. 2 by a dashed circumferential line. Through lowering (in opposite B1 direction) of the attachment structure 21 this is transferred to the closed setting before the elevator car 10 goes into the normal operational state. The attachment structure 21 is so selected in terms of dimensions that it here engages around or covers not only the elevator car 10 in the interior of the car frame 14, but also the upper part of this frame 14. Thus, wind caused by travel, which flows against the entire composite unit from above, is conducted past the elevator car 10 together with car frame 14.

An elevator car according to the invention is shown in FIG. 3 the attachment structure 21 of which comprises a stationary substructure 22 and a movable superstructure 23. This is thus a two-part attachment structure 21. This form of embodiment is designed so that the substructure 22 remains in position on transfer to the open state and only the superstructure 23 is shifted, displaced, folded away, rotated or pivoted. In the case of the form of embodiment shown in FIG. 3, the substructure 22 is seated at least partly at the level of the upper crossbeam 14.1. The superstructure 23 is placed from above on the substructure 22. In FIG. 3 the superstructure 23 is indicated once in the closed state and once in the open state. In the closed state the superstructure bears the reference numeral 23.g and in the open state the reference numeral 23.o. The form of embodiment is additionally distinguished by the fact that the substructure 22 has inclined flanks 22.1 which correspond with corresponding inclined flanks 23.1 of the superstructure 23. This flank shape is optional.

Details of a form of embodiment of the invention are shown in the perspective

FIGS. 4A and 4B. Here, too, this is an elevator car 10 with a car frame 14. However, here two lateral parallel beams 14.2 are arranged on each side of the elevator car 10, the upper profile of which is indicated by dashed lines. The, in total, four, lateral beams 14.2 are connected above the elevator car 10 with a crossbeam 14.1 (here a double-T-beam). A corresponding lower crossbeam 14.3 (see, for example, FIG. 3) can be arranged below the elevator car 10.

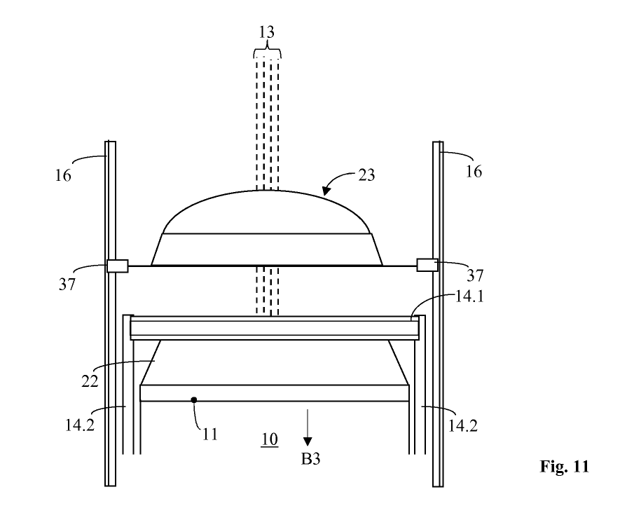

Three guide rollers 15, which are so designed that they roll along vertical guide rails 16 (see, for example, FIG. 11) and guide the elevator car 10, are indicated on the lefthand side of the elevator car 10. Analogously, further guide rollers 15 are also arranged on the righthand side above as well as below the elevator car 10 on both sides. These further guide rollers 15 are not shown in FIGS. 4A and 4B.

In the closed state, which is shown in FIG. 4A, the two-part attachment structure 21, comprising a stationary substructure 22 and a movable superstructure 23, is seated directly on or above the upper side 11 of the elevator car 10. In the case of a central 1:1 suspension of the elevator car 10, the or each support means 13 runs through a recess 24 in the superstructure 23.

In the open state, which is shown in FIG. 4B, the superstructure 23 was completely raised, as indicated by the arrow B1. The superstructure 23 has, as is apparent, the shape of a hood. After transfer into the open state, it frees a route or access to elements or components of the elevator car 10 at the roof side. Details of the upper crossbeam 14.1 can be seen in FIG. 4B. The three support means 13, which are used here, are led centrally through the crossbeam 14.1 and fastened in a fastening plate 12 (which serves as fastening means). This fastening plate 12 is seated below the crossbeam 14.1. If the support means 13 are loaded in tension, the fastening plate 12 is then pressed against the underside of the crossbeam 14.1.

In FIG. 4B it can be seen that the substructure 22 has, apart from the inclined flanks 22.1, additionally straight vertically extending flanks 22.2. The substructure 22 surrounds the edge of the upper side 11 of the elevator car 10 and in that case forms a balustrade or a railing.

In this embodiment the superstructure 23 also has inclined flanks 23.1, the shape and inclination of which are matched to those of the inclined flanks 22.1 of the substructure 22, so that the superstructure 23 can be pushed onto or placed on the substructure 22.

A small, roof-like projection 25, as can be seen in FIG. 4A, preferably results in order to allow the air flow to flow around the body of the elevator car 10.

A perspective illustration of a further aerodynamic cladding 20 with a two-part attachment structure 21 is shown in FIG. 5 in an open setting. This form of embodiment is distinguished by the fact that vertical elements 26, 27 are provided on the car front side not only at the substructure 22, but also at the superstructure 23. These vertical elements 26, 27 define the car front side, on which the car doors and the door drive are located (not shown). A wind deflector 27.1 is mounted on the front upper side. In order in the open state of the attachment structure 21 to free access to the upper side 11 of the elevator car 10 and to the region 28 surrounded by the substructure 22 a door, flap or cover plate 29 can be mounted on the vertical element 26. This door, flap or cover plate 29 can be screw-connected with the vertical element 26 or suspended at the vertical element 26.

In FIG. 5 it can be seen that the substructure 22 is designed as a support frame with cladding. Elements or sections of the support frame are provided in FIG. 5 with the reference numeral 30. Cladding elements in the form of sheet-metal plates or plastics material plates are mounted (for example, riveted, screw-connected or glued) on this support frame 30.

The vertical elements 26, 27 inclusive of access opening, which is covered by a door, flap or cover plate 29, can also be used in all other forms of embodiment.

Lateral cut-outs 31 are, for example, provided at the superstructure 23 in order to create space for the structural elements (for example the lateral beams 14.2) and components of the elevator car 10. A recess 24 for the passage of the support means 13 can, as already mentioned, be provided on the upper side 23.2 of the superstructure 23.

The substructure 22 according to FIG. 5 has, apart from the inclined flanks 22.1, also straight vertically extending flanks 22.2, which together surround the upper side 11 of the elevator car 10 in the form of a balustrade or a railing. A protected region 28 for assembly, maintenance and evacuation purposes is thereby created.

In the design or laying-out of an elevator car 10 according to the present invention the following rule can be employed depending on the gap width between the elevator car 10 and the elevator shaft.

If the gap width between elevator car 10 and elevator shaft is smaller than 300 millimeters, then a balustrade is not necessary. In this case, a one-part form of embodiment (for example, according to FIGS. 1A, 1B or FIG. 2) can be used.

If the gap width is between 300 and 850 millimeters, then the balustrade height H should be greater than 700 millimeters (see FIG. 5). If the gap width is greater than 850 millimeters, then the balustrade height H should be greater than 1100 millimeters.

However, the use of this rule is optional.

With reference to FIGS. 6 to 11, different forms of embodiment and designs of the opening mechanism 40 are now described. The various opening mechanisms 40 can be used on all forms of embodiment and can be selected and adapted as needed.

In FIG. 6 a form of embodiment is shown in which two vertical guide rails 41 are provided in the region above the upper side of the elevator car 10. The superstructure 23 is movably guided along these guide rails 41, for example by means of slide shoes or rollers 44. Two hydraulically driven pivot arms 42 with rollers or slide elements 43 are provided at the upper crossbeam 14.1 or in the region of the upper crossbeam 14.1. These rollers or slide elements 43 engage under or in the superstructure 23 and urge this upwardly, as indicated by the arrow B1. The two hydraulically driven pivot arms 42 can have per pivot arm, for example, a compression spring 45 (for example, a gas spring).

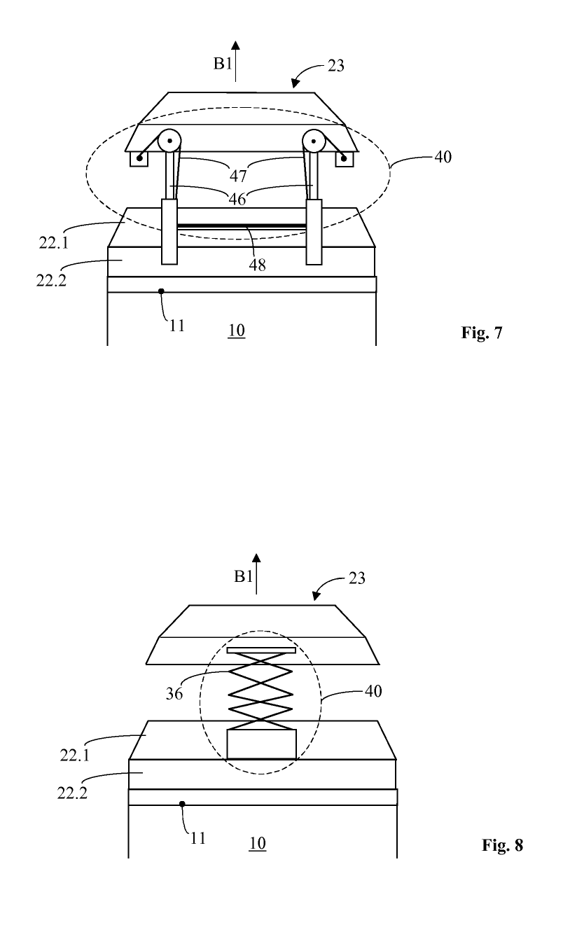

A form of embodiment is shown in FIG. 7 in which in the region above the upper side 11 of the elevator car 10 two vertical cylinders or spindle drives 46 are provided. When the cylinder is moved out or the spindle drive 46 is screwed out the superstructure 23 is moved upwardly as indicated by the arrow B1. The superstructure 23 can optionally be suspended at traction means 47, as indicated in FIG. 7. In that case, the first ends of the traction means 47 are fastened in the region of the substructure 23, the upper side 11 of the elevator car 10 or the stationary part of the cylinder or spindle drive 46. The traction means 47 are then guided around deflecting rollers, which are each fastened to a respective movable or extendable part of the cylinder or spindle drive 46. Finally, the second ends of the traction means 47 are fastened to the superstructure 23. In this optional form of embodiment the lifting force of the cylinder or spindle drive 46 acts indirectly on the superstructure 23 via the traction means 47.

For synchronization of the opening movement B1, use can be made of an optional synchronization shaft 48. A variation of this form of embodiment provides, for example, a synchronization shaft 48 with two transmissions for force transfer to the two spindle drives 46. In this case, the central (common) synchronization shaft 48 is preferably driven. The relevant drive is not shown.

A variation of this form of embodiment provides, for example, hydraulic cylinders or gas-driven cylinders 46 which drive upwardly through application of a gas pressure or fluid pressure. The pistons in turn move the superstructure 23 upwardly. Instead of the synchronization shaft 48, a common pressure distributor can here ensure that the two cylinders 46 respectively have the same pressure and are thus moved synchronously.

A form of embodiment is shown in FIG. 8 in which a scissors mechanism 36 is provided in the region above the upper side 11 of the elevator car 10 and serves as opening mechanism 40. The superstructure 23 is displaced in the illustrated manner laterally upwardly by actuation of the scissors mechanism 36. The corresponding opening movement B1 is indicated in FIG. 8 by an arrow.

A form of embodiment is shown in FIGS. 9A to 9C in which a form of scissors mechanism or flap mechanism 38, which serves as opening mechanism 40, is provided in the region above the upper side 11 of the elevator car 10. In FIG. 9A the cladding 20, which here comprises only a unitary attachment structure 21, is shown in the closed state. The arms of the scissors or flap mechanism 38 here lie horizontally and are folded together. An intermediate state of the opening phase is shown in FIG. 9B. It can be seen that the scissors or flap mechanism 38 has on each side two pivotably interconnected arms which are actuated by a drive (not shown) and raise the attachment structure 21. The completely open state is shown in FIG. 9C. The arms of the scissors or flap mechanism 38 are detented at the points X in order to impart stability to the entire system.

Those forms of embodiment which were described in connection with FIGS. 6, 7, 8 and 9A to 9C are distinguished by the fact that the opening movement B1 is produced by opening mechanisms 40 which are seated directly at or on the elevator car 10 or at or on the car frame 14. These opening mechanisms 40 can also be fixed to the substructure 22. All illustrated opening mechanisms 40 can be used for raising or lowering unitary attachment structures 21 or, in the case of a two-part construction of the attachment structure 21, for raising or lowering the superstructure 23.

An exemplifying form of embodiment, which is placed at the support means 13, is described in the following.

A corresponding form of embodiment is shown in FIG. 10, in which an attachment point 31 is provided at the support means 13 in the region above the upper side 11 of the elevator car 10. Provided at the attachment point 31 is, for example, a clamping body 32 or a cable clamp which is firmly clamped to the support means 13. A deflecting roller 33 is seated on the clamping body 32. A traction cable 34 is provided, which extends from the substructure 22, which is fixedly arranged at the upper side 11 of the elevator car 10, over the deflecting roller 33 to the movable superstructure 23. The traction cable 34 can, for example, be pulled in from the substructure 22, as indicated by the arrow B2, by a drive, for example in the form of a winch (not shown). If the traction cable 34 is pulled in arrow direction B2, then an opening movement of the superstructure 23 is executed, as indicated by the arrow B1. In this form of embodiment a support means guide 35 is preferably provided in the region of the recess 24 so as to enable upward displacement of the superstructure 23 without problems.

This form of opening mechanism can also be used with unitary attachment structures. In that case, the traction cable 34 is pulled in in the region of the upper side 11 of the elevator car 10 in order to raise or lower the attachment structure 21 as a whole.

An exemplifying form of embodiment of a two-part attachment structure, which is placed on the stationary guide rails 16 present in the elevator shaft, as shown in FIG. 11, is described in the following. Mounted in the region of the superstructure 23 are clamping bodies 37 which enable temporary clamping fast to the guide rails 16. The sequence is now as follows. If access to the elements and components of the elevator car 10 at the roof side is desired the elevator car 10 is moved into a predetermined position in the elevator shaft. The clamping bodies 37 are then clamped (manually or automatically, for example by a setting motor) to the guide rails 16. The superstructure 23 is now connected with the guide rails 16 by way of the clamping bodies 37. In a next step the elevator car 10 executes a downward movement B3. During this downward movement B3 the superstructure 23 remains at the predetermined location. By virtue of the downward movement B3 a relative opening movement between elevator car 10, which here preferably carries a substructure 22, and the superstructure 23 arises.

This form of embodiment can also be used on elevator cars 10 which have only a one-part attachment structure 21 without division into substructure 22 and superstructure 23. In this regard, clamping bodies 37 are fastened to the attachment structure 21. On actuation of the clamping bodies 37 and downward movement B3 of the elevator car 10 a relative opening movement between the elevator car 10 and the attachment structure 21 arises in analogous manner.

It is an advantage of the clamping fast of the superstructure 23 to the guide rail 16 that the elevator car 10 (with or without substructure 22) can be moved in the elevator shaft in slow travel in order, for example, to be able to repair elements or components at the shaft. During this slow travel the superstructure 23 or the entire attachment structure 21 remains in a parked position.

The clamping fast of the superstructure 23 or of the entire attachment structure 21 to the guide rail 16 can be carried out, for example, by clamping bodies 37, which have an eccentrically mounted lever which through a rotational movement about an axis exerts a clamping action on the respective guide rail 16.

In the example of FIG. 11, the opening mechanism comprises, apart from the clamping bodies, the drive of the elevator as an integral component.

However, the various opening mechanisms 40 can also be designed for manual raising, possibly assisted by a (gas pressure) spring or similar. A manual operation, for example with a crank or similar, can also be provided.

The opening mechanism 40 is preferably activated automatically when the elevator installation is set into a maintenance mode or if evacuation is present.

The superstructure 23 can in the various forms of embodiment have a support frame (analogously to the support frame 30) with cladding elements or a self-supporting cladding structure.

The forms of embodiment shown in FIGS. 1 to 11 are distinguished by the fact that at least the movable part of the attachment structure, thus the attachment structure 21, is transferable as a whole or, for example, the superstructure 23 by means of a vertical translational movement from a closed state to an open state.

Depending on the respective requirements an aerodynamic cladding can also be arranged on the underside of the elevator car 10.

According to the invention an elevator installation with an elevator car 10, which comprises an aerodynamic cladding 20 which as considered in upward travel direction of the elevator car 10 is located above an upper side 11 of the elevator car 10, is so operated that in a special situation (maintenance, assembly or, for example, in the case of evacuation) the elevator car 10 is transferred into a stopped position (for example in the region of the upper shaft end). In this stopped position one of the opening mechanisms 40 is manually or automatically driven so as to transfer at least a movable part of the attachment structure 21 from the closed state to the open state.

At least the movable part of the attachment structure 21, 23 of the elevator car 10 is thus transferable by means of a vertical translational movement from a closed state to an open state.

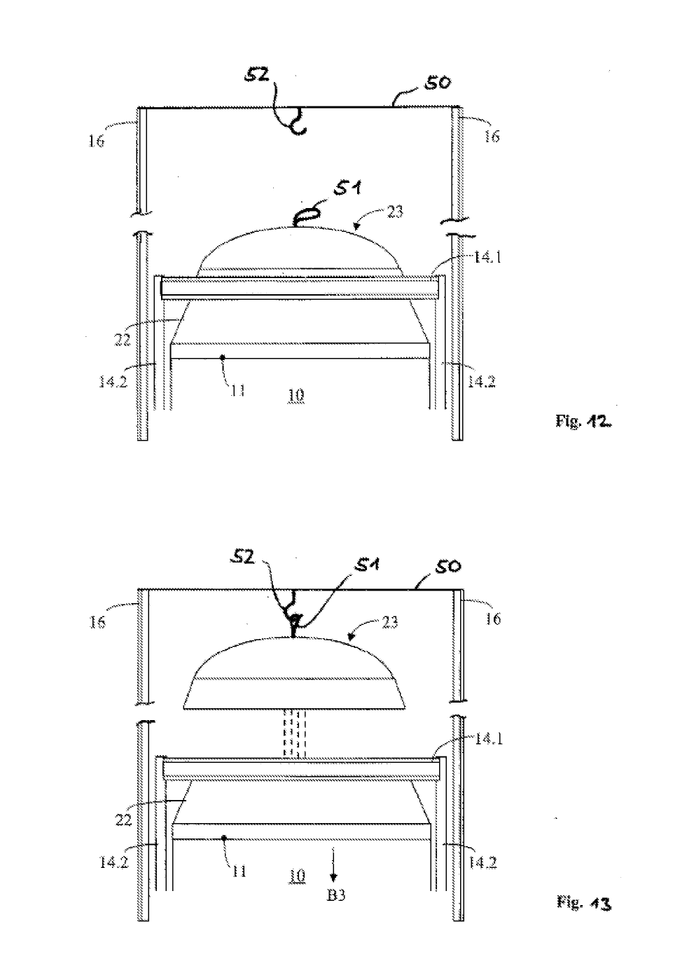

Alternatively, the superstructure 23 can be brought into a parked position by temporary connection with the shaft roof. A corresponding embodiment is illustrated in FIGS. 12 and 13, wherein for clarification of the function the support means are, for the sake of simplicity, not illustrated. FIG. 12 shows the elevator car 10 shortly before reaching the uppermost setting. Serving as holding means at the car side is, for example, a loop 51 of a suitable tear-resistant material, which is mounted at the upper end of the superstructure 23. A hook 52 as counter-holder is arranged on the opposite side on an underside of the shaft ceiling 50. The elevator is stopped in the uppermost setting and the loop 51 is introduced into the hook 52 and thus the superstructure 23 is temporarily fixed to the shaft ceiling. Thereafter, the car 10 can be moved downwardly while the superstructure 23 is fixed to the shaft ceiling 50. An elevator car in a state opened in that manner is illustrated in FIG. 13. Other forms of connection are obviously also conceivable instead of the hook/loop connection shown here. Analogously to the foregoing embodiment a superstructure able to be coupled to the shaft ceiling could also be brought into the parked position by way of a clamping connection. Also conceivable, for example, are holding means automatically coupling to the shaft ceiling in the case of upward movement of the car. Thus, detent means with detent lugs, in which complementary detent segments associated with the superstructure can be detented, could be arranged at the shaft ceiling. A decoupling mechanism would then be conceivable for releasing the connection.

Moreover, for specific purposes of use it would also be conceivable to execute the claddings according to the variants of embodiment of FIGS. 10 and 11 as well as 12 and 13 merely with a respective superstructure (or without substructure).

In accordance with the provisions of the patent statutes, the present invention has been described in what is considered to represent its preferred embodiment. However, it should be noted that the invention can be practiced otherwise than as specifically illustrated and described without departing from its spirit or scope.

1-15. (canceled)

16. An elevator car with an aerodynamic cladding which, relative to an upward travel direction of the elevator car in an elevator shaft, is disposed above an upper side of the elevator car and is connected with the elevator car, comprising:
a self-supporting attachment structure forming the cladding and including a movable superstructure and a substructure, wherein the substructure is fixedly connected with the elevator car and wherein the superstructure is hood-shaped; and
an opening mechanism for transferring the superstructure of the attachment structure from a closed state covering the upper side of the elevator car to an open state exposing the upper side of the elevator car, wherein the superstructure is vertically translationally movable relative to the elevator car.

17. The elevator car according to claim 16 wherein the superstructure of the attachment structure is in the closed state disposed closer to the upper side of the elevator car than when in the open state.

18. The elevator car according to claim 16 wherein the elevator car includes a carrying car frame which at least partly encloses or surrounds the elevator car.

19. The elevator car according to claim 16 wherein the substructure forms a balustrade or railing which extends about a protected region above the elevator car.

20. The elevator car according to claim 16 wherein the attachment structure includes in a region of a front side of the elevator car vertical elements forming an access opening which after removal or opening of an attached door, flap or cover plate frees access to a region above the elevator car.

21. The elevator car according to claim 16 wherein the opening mechanism includes at least one of the following manually or automatically drivable mechanisms: pivot arms; cylinder; spindle drive; scissors mechanism; and flap mechanism.

28. The elevator car according to claim 16 wherein the opening mechanism includes a clamping body having a deflecting roller and which is fastened to a support of the elevator car.

29. The elevator car according to claim 16 wherein the opening mechanism includes a holding device temporarily fastenable to counter-holders that are associated with the elevator shaft to bring the superstructure into a parked position.

30. The elevator car according to claim 16 wherein the opening mechanism includes clamping bodies that are temporarily fastenable to stationary guide rails in the elevator shaft.

31. The elevator car according to claim 16 wherein the superstructure includes at least one holding element for coupling to a coupling element arranged at a shaft ceiling of the elevator shaft.

32. An elevator car having an aerodynamic cladding which, relative to an upward travel direction of the elevator car in an elevator shaft, is disposed above an upper side of the elevator car and is connected with the elevator car, comprising:
a self-supporting attachment structure forming the cladding and including a movable hood-shaped superstructure; and
an opening mechanism for transferring the superstructure of the attachment structure from a closed state covering the upper side of the elevator car to an open state exposing the upper side of the elevator car, wherein the superstructure is vertically translationally movable relative to the elevator car and wherein the opening mechanism includes a holding device temporarily fastenable to counter-holders that are associated with the elevator shaft to hold the superstructure in a parked position to permit the elevator car to move to an open state position.

33. The elevator car according to claim 32 wherein the counter-holder are stationary guide rails in the elevator shaft and the opening mechanism includes clamping bodies temporarily fastenable to the stationary guide rails.

34. The elevator car according to claim 32 wherein the counter-holders include a coupling element arranged at a shaft ceiling of the elevator shaft and the superstructure includes at least one holding element for coupling to the coupling element.

35. A method of operating an elevator installation with an elevator car having an aerodynamic cladding, which in an upward travel direction of the elevator car in an elevator shaft, is disposed above an upper side of the elevator car, comprising:
transferring the elevator car to a holding position when a special situation exists in the elevator installation; and
in the holding position driving an opening mechanism either manually or automatically to transfer at least one movable part of an attachment structure on the elevator car from a closed state in a vertical translational movement to an open state, wherein the attachment structure in the closed state forms the aerodynamic cladding of the elevator car.

36. The method according to claim 35 including a step of removing or opening a door, a flap or a cover plate of the attachment structure to free a passage opening, which in normal operation of the elevator installation is covered by the door, flap or cover plate, to provide access to an upper side of the elevator car or an escape from the upper side of the elevator car.

37. The method according to claim 36 wherein when the car is in the holding position, temporarily mounting a holding device on counter-holders associated with the elevator shaft to fix the movable part of the attachment structure in the elevator shaft, and then moving the elevator car downward movement to create a spacing between the upper side of the elevator car and the movable part of the attachment structure.

38. The method according to claim 36 wherein the special situation is one of an assembly situation, a maintenance situation and an evacuation situation.
